(19) United States
(12) Patent Application Publication
(10) Pub. No.: US 2010/0309913 A1
(43) Pub. Date: Dec. 9, 2010

(54) METHOD AND SYSTEM FOR HANDLING IPTV MULTICAST TRAFFIC IN A HOME NETWORK

(76) Inventors: Nick Herodotou, Fremont, CA (US); Rajesh Mamidwar, San Diego, CA (US); Sanjeev Sood, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 12/479,739

(22) Filed: Jun. 5, 2009

(51) Int. Cl. H04L 12/56

(52) U.S. Cl. 370/390

(57) ABSTRACT

A home network (HN) server is configured to terminate IP-based multicast packets received from, for example, an external IPTV service distribution network and record in storage of the HN server. The HN server transmits the terminated multicast packets to a plurality of HN clients based on corresponding link quality between each of the HN clients and the HN server. A transmission mode and local IP protocols are determined based on corresponding link quality for each of the HN clients. The recorded multicast packets are reformatted based on the determined local IP protocols and transmitted in the determined transmission mode to corresponding HN clients. The HN server acquires expected recorded multicast packets when not available in its storage from peer HN servers and reformats the acquired expected recorded multicast packets based on the determined local IP protocols for transmission. Packet transmission are suspended or resumed according to a client service pause.

### CROSS-REFERENCE TO RELATED APPLICATIONS/INCORPORATION BY REFERENCE

Not Applicable.

### FIELD OF THE INVENTION

Certain embodiments of the invention relate to communication systems. More specifically, certain embodiments of the invention relate to a method and system for handling IPTV multicast traffic in a home network.

### BACKGROUND OF THE INVENTION

A home network is an Internet Protocol (IP) based network that interconnects various end devices such as a set-top box (STB) in a home to each other to access networks for various IP-based services such as IP-based TV (IPTV) service. IPTV service is an application in a multicast network that provides delivery of broadcast TV and other media-rich services over a secure, end-to-end operator managed broadband IP data network. The IPTV service leverages the benefits provided by IP multicast to provide scalability for the increasing number of viewers and TV channels. In the IPTV service, each channel is carried by one multicast group. When a user wants to watch a program on a certain channel, the user needs to be added to a multicast group corresponding to the certain channel. When the user changes channels for a new channel, the user may be added to a new multicast group corresponding to the new channel and deleted from the previous multicast group to which they were added. A two-way interactive capability in the IPTV service may enable the user to control what content to watch and when to what such content. The user may join a multicast group and may leave the multicast group dynamically. The IPTV service enables more content variety with a plurality of channels. This makes it possible to provide a very diverse range of content so to serve the demands and interests of mass markets, specialized groups and/or demographic communities.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for handling IPTV multicast traffic in a home network, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary IPTV system that enables end-to-end service management within home network to support QoS services, in accordance with an embodiment of the invention.

FIG. 2 is a block diagram illustrating an exemplary home network server that is operable to provide end-to-end service management of IPTV service, in accordance with an embodiment of the invention.

FIG. 3 is a block diagram illustrating an exemplary home network client that is operable to receive IPTV service with desired QoS, in accordance with an embodiment of the invention.

FIG. 4 a flow chart illustrating an exemplary end-to-end service management procedure for the delivery of IPTV service in home network, in accordance with an embodiment of the invention.

FIG. 5 is a flow chart illustrating an exemplary resource sharing procedure for a seamless IPTV service in home network, in accordance with an embodiment of the invention.

FIG. 6 is a flow chart illustrating an exemplary seamless pause procedure in IPTV service within home network, in accordance with an embodiment of the invention.

### DETAILED DESCRIPTION OF THE INVENTION

Certain embodiments of the invention may be found in a method and system for handling IPTV Multicast traffic in a home network. In an exemplary embodiment of the invention, a home network (HN) server may be configured to terminate IP-based multicast packets such as multicast IPTV packets received from an entity such as an IPTV service distribution network that is external to the home network. The HN server is operable to transmit the terminated multicast IPTV packets to a plurality of HN clients in the home network based on corresponding link quality such as, for example, a packet error rate between each of the plurality of HN clients and the HN server. The HN server may enable storage of the HN server to record the terminated multicast IPTV packets to be utilized for IPTV service within the home network. The HN server may be operable to determine a transmission mode for each of the plurality of HN clients based on corresponding link quality between each of the plurality of HN clients and the HN server. The determined transmission mode may be utilized for transmission of the recorded multicast IPTV packets stored in the storage. The HN server may be operable to determine one or more local IP protocols based on corresponding link quality for each of the plurality of HN clients. The determined one or more local IP protocols may be used for transmission of the recorded multicast IPTV packets in the corresponding determined transmission mode. The recorded multicast IPTV packets in the storage may be reformatted based on the determined one or more local IP protocols prior to transmission.

The HN server may be operable to transmit the reformatted multicast IPTV packets in the determined transmission mode to the plurality of HN clients. The HN server may be operable to share resources with peer HN servers in the home network. For example, the HN server may be operable to acquire expected recorded multicast IPTV packets from the peer HN servers when the expected recorded multicast IPTV packets are not available in its own storage. The HN server may be enabled to reformat the acquired multicast IPTV packets based on the determined local IP protocols for transmission in the determined transmission mode to the plurality of HN clients. The HN server may be operable to suspend IPTV packet transmission to a specific HN client during a service pause at the specific HN client. The IPTV packet transmission may be resumed after the service pause at the specific HN client.

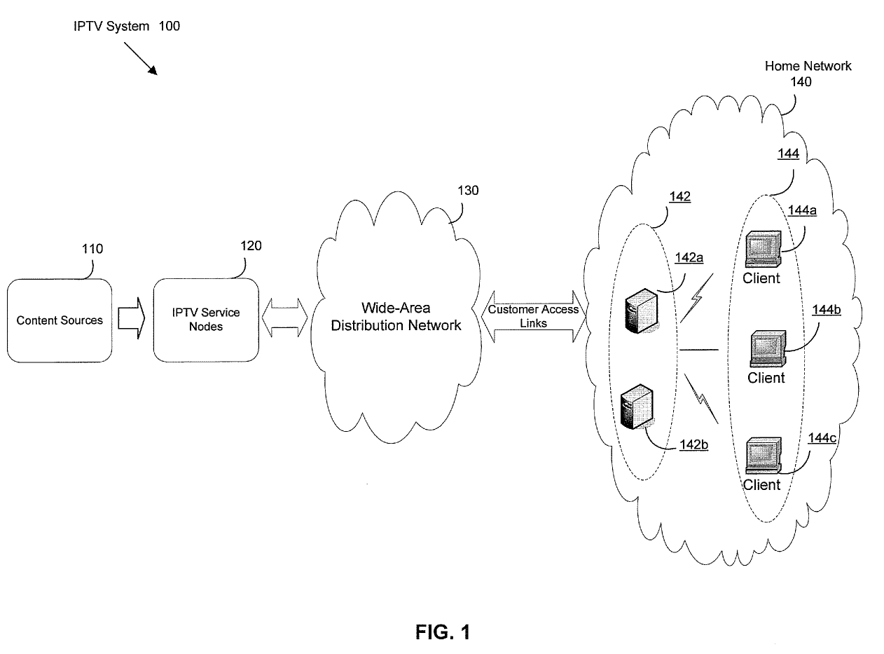

FIG. 1 is a diagram illustrating an exemplary IPTV system that enables end-to-end service management within home network to support QoS services, in accordance with an embodiment of the invention. Referring to FIG. 1, there is shown an IPTV system 100 comprising content sources 110, IPTV service nodes 120, a wide-area distribution network 130 and a home network (HN) 140. The home network 140 comprises a plurality of home network (HN) servers 142, of which HN servers 142a-142b are displayed, and a plurality of home network (HN) clients 144, of which HN clients 144a-144c are presented.

The content sources 110 may comprise suitable logic, circuitry, interfaces and/or code that are operable to receive IPTV content from producers and other sources. The content sources 110 may be operable to encode the received IPTV content in various formats. The content sources 110 may be operable to store the coded IPTV content utilized to support various IPTV applications such as video-on-demand (VoD) services.

The IPTV service nodes 120 may comprise suitable logic, circuitry, interfaces and/or code that are operable to receive coded IPTV content from the content sources 110. The IPTV service nodes 120 may be enabled to encapsulate the received coded IPTV content to transmit the encapsulated IPTV content in IPTV packets with appropriate Quality of Service (QoS) to the home network 140 via the wide-area distribution network 130.

The wide-area distribution network 130 may comprise suitable logic, circuitry, interfaces and/or code that are operable to distribute IPTV packets from the IPTV service nodes 120 to the home network 140. The wide-area distribution network 130 may be configured to provide capacity and various capabilities such as, for example, distribution, multicast, and/or quality of service necessary for a reliable and timely transmission of the IPTV packets to the home network 140. The wide-area distribution network 130 may be operable to multicast the IPTV packets to the home network 140 over customer access links. Depending on the richness of IPTV service offerings, the customer access links may be implemented using various technologies, for example, higher-speed DSL technologies, Fiber-to-the-Home (FTTH) access technology or a combination of Fiber-to-the Curb (FTTC) and DSL technologies.

The home network 140 may comprise suitable logic, circuitry, interfaces and/or code that are operable to connect the HN servers 142 and the HN clients 144 to support various home networking services such as IPTV service. A HN server such as the HN server 142a may comprise suitable logic, circuitry, interfaces and/or code that are operable to transmit and/or forward multicast IPTV packets from the wide-area distribution network 130 to the HN clients 144. Connections between the HN server 142a and associated HN clients such as the HN client 144a may be wired and/or wireless. The HN server 142a may be configured to support packet transmission in unicast mode and/or in multicast mode. In unicast mode, the HN server 142a may be operable to send packets to a single recipient such as the HN client 144a at a time. In multicast mode, the HN server 142a may be operable to send the same packets to multiple recipients such as the HN clients 144a-144c at a time. For IPTV service, the HN server 142a may be configured to terminate and record the multicast IPTV packets from the wide-area distribution network 130. The HN server 142a may be operable to provide QoS management for delivering appropriate recorded multicast IPTV packets to the HN clients 144. In this regard, the HN server 142a may be operable to evaluate corresponding link quality with respect to each of associated HN clients such as the HN clients 144a-144c. Depending on corresponding link quality, the HN server 142a may be operable to determine or select a transmission mode (unicast mode or multicast mode) and local IP protocols for the delivery of the recorded multicast IPTV packets to each of associated HN clients. Following real-time compilation of the recorded multicast IPTV packets, appropriate recorded multicast IPTV packets may be reformatted based on the determined local IP protocols. The HN server 142a may be operable to transmit the reformatted recorded multicast IPTV packets to corresponding HN clients such as the HN client 144a in the determined transmission mode.

An IPTV client such as the client 144a may comprise suitable logic, circuitry, interfaces and/or code that are operable to perform various functional processing such as, for example, setting up connections and associated QoS with corresponding HN server such as the HN server 142a, decoding IPTV packets from the HN server 142a, and/or managing channel change functionality, user display control, and/or connections to user appliances such as a standard-definition TV (SDTV) or a high-definition TV (HDTV) monitors. For IPTV service, the client 144a may be operable to receive IPTV packets in unicast mode or in multicast mode depending on corresponding link quality with the HN server 142a.

In operation, the content sources 110 may be enabled to receive IPTV content utilized for IPTV applications. The received IPTV content may be encoded and communicated with the IPTV service nodes 120. The IPTV service nodes 120 may be operable to encapsulate the coded IPTV content for transmission in IPTV packets to the wide-area distribution network 130. The wide-area distribution network 130 may be operable to muticast the received IPTV packets to the home network 140. The HN servers 142 in the home network 140 may be configured to terminate and record the received multicast IPTV packets from the wide-area distribution network 130. Depending on corresponding link quality, the HN server 142a may be operable to determine a transmission mode (unicast mode or multicast mode) and local IP protocols for the delivery of the recorded multicast IPTV packets to associated HN clients. The HN server 142a may be operable to reformat appropriate recorded multicast IPTV packets based on the determined local IP protocols and forward the resulting formatted information to corresponding HN clients such as the HN client 144a in the determined transmission mode.

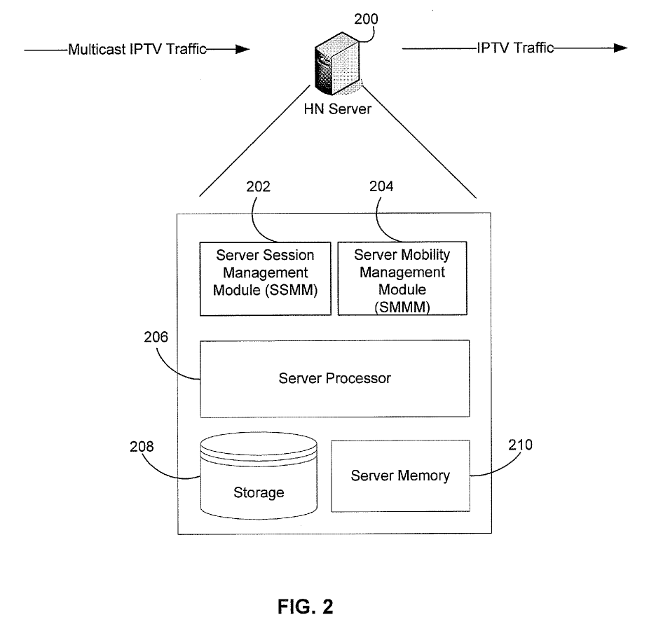

FIG. 2 is a block diagram illustrating an exemplary home network server that is operable to provide end-to-end service management of IPTV service, in accordance with an embodiment of the invention. Referring to FIG. 2, there is shown a home network server 200 comprising a server session management module (SSMM) 202, a server mobility management module (SMMM) 204, a server processor (SP) 206, a storage 208 and a server memory (SM) 210.

The SSMM 202 may comprise suitable logic, circuitry, interfaces and/or code that are operable to monitor network connectivity within the home network 140 and handle various session signaling messages with the HN clients 144. The session signaling messages may comprise service request and/or QoS request messages. For example, upon the receipt of a request from a HN client such as the HN client 144a for a program in IPTV service via the SP 206, the SSMM 202 may be operable to execute various operations related to, for example, admission control, communication session setup, connection maintenance and connection termination. The SSMM 202 may be operable to establish a session with the HN client 144a for the requested program in IPTV service. Depending on corresponding link quality such as a packet error rate, the SCMM 202 may be operable to establish sessions in unicast mode and/or multicast mode for communication of the requested program in IPTV service. With a session in multicast mode, the SSMM 202 may be operable to manage the session in multicast mode for the delivery of IPTV packets of scheduled programs on a (subscribed) multicast channel to HN clients such as the HN client 144a of corresponding multicast group.

Content in the (subscribed) multicast channel may be updated, either automatically or on requests. Content of the last program currently scheduled on the (subscribed) multicast channel may be stored and may be overwritten when a new scheduled program may begin in the (subscribed) multicast channel. This may allow a fast channel change for associated HN clients inside the home network 140 and provide access to the start of the last program on the (subscribed) multicast channel. The SSMM 202 may be operable to terminate the (subscribed) multicast channel at the end of scheduled programs. In this regard, information such as client access to the last scheduled program may be multicast prior to the termination of the (subscribed) multicast channel. Information regarding the termination of the (subscribed) multicast channel may be communicated across peer HN servers such as the HN server 142b for load balancing in processing and/or storage demands within the home network 140.

The SSMM 202 may be operable to manage the membership of, for example, the HN client 144a in the corresponding multicast group. In addition, the SSMM 202 may be operable to select local IP protocols used for delivering IPTV packets of the requested program to the HN client 144a based on corresponding link quality. A flow control mechanism may be applied for IPTV packet delivery in the established session in unicast mode depending on, for example, corresponding link quality. Link quality may be determined based on, for example, packet error rate, bit error rate, signal to noise ratio, and/or carrier and/or signal to interference noise ratio.

The SMMM 204 may comprise suitable logic, circuitry, interfaces and/or code that are operable to manage mobility information such as, for example, HN server addresses, HN server locations, HN client addresses and HN client locations. The SMMM 204 may be configured so that it may be operable to provide mobility information such as a peer HN server address to the SP 206 for acquiring appropriate recorded multicast IPTV packets for sharing resources within the home network 140.

The SP 206 may comprise various types of processors or circuitry such as a microprocessor, a digital signal processor, an Application Specific Integrated Circuit (ASIC), or a combination of processing type devices. The SP 206 may be operable to execute a plurality of software instructions, which may be stored in the SM 210 and downloaded for execution. In this regard, the SP 206 may be configured to generate session IDs for various sessions using algorithms stored in the SM 210. In an exemplary embodiment of the invention, the SP 206 may enable the storage 208 to record multicast IPTV packets received from the wide-area distribution network 130 to provide access to the starts of last multicast programs on each of subscribed multicast channels to the home network 140. In this regard, the most current multicast IPTV packets of the recording (on the order of seconds) may be stored in DRAM to facilitate a fast channel change while the remainder of the recording (up to several hours) may be stored on the storage 208 to provide access to the starts of last multicast programs on each of subscribed multicast channels. The SP 206 may be enabled to reformat appropriate recorded multicast IPTV packets based on the selected local IP protocols in the SSMM 202. The SP 206 may be operable to transmit the reformatted recorded multicast IPTV packets to associated HN clients such as the HN client 144a. In another exemplary embodiment of the invention, the SP 206 may be operable to communicate with peer HN servers in the home network 140 for sharing resources in IPTV service. In this regard, the SP 206 may be enabled to acquire appropriate recorded multicast IPTV packets from peer HN servers to support seamless pause and/or provide a seamless user experience in IPTV service within the home network 140.

The storage 208 may comprise suitable logic, circuitry, interfaces, and/or code that may be enabled to record and store multicast IPTV packets. The stored multicast IPTV packets may be provided to the SP 206 to support programs in IPTV service. The storage 208 may comprise magneto and/or optical drivers such as a hard disk. The storage 208 may also comprise solid state memory such as flash memory and/or other suitable electronic data storage capable of recording and storing data and instructions.

The SM 210 comprises suitable logic, circuitry, interfaces and/or code that are operable to store data and/or other information utilized by the HN server 200. For example, the SM 210 may be utilized to store processed data generated by the SP 206. The SM 210 may also be utilized to store information such as session profiles that may be utilized to control various operations of the HN server 200. The SM 210 may be operable to store information necessary to enable or disable a flow control for an established session in unicast mode. The SM 210 may be operable to store information of multicast group membership for HN clients with sessions in multicast mode. The SM 210 may also be operable to store some executable instructions, for example, for session set-up and/or session profile update. The SM 210 may comprise RAM, ROM, low latency nonvolatile memory such as flash memory and/or other suitable electronic data storage capable of storing data and instructions.

In operation, the HN server 200 may be operable to receive multicast IPTV packets from the wide-area distribution network 130. The SP 206 may enable the storage 208 to record and store the received multicast IPTV packets. Depending on corresponding link quality such as a packet error rate, the SSMM 202 may be operable to select local IP protocols and establish a session with, for example, the HN client 144a. The established session may be implemented in unicast mode or in multicast mode based on corresponding link quality. Prior to packet transmission, the SP 206 may be configured to reformat appropriate recorded multicast IPTV packets in the storage 208 based on the selected local IP protocols in the SSMM 202. For example, the appropriate recorded multicast IPTV packets may be reformatted in a way of converting the format of the appropriate recorded multicast IPTV packets in the storage 208 to a format compatible to the selected local IP protocols. Accordingly, the SP 206 may be operable to transmit the reformatted recorded multicast IPTV packets to the HN client 144a in the established session.

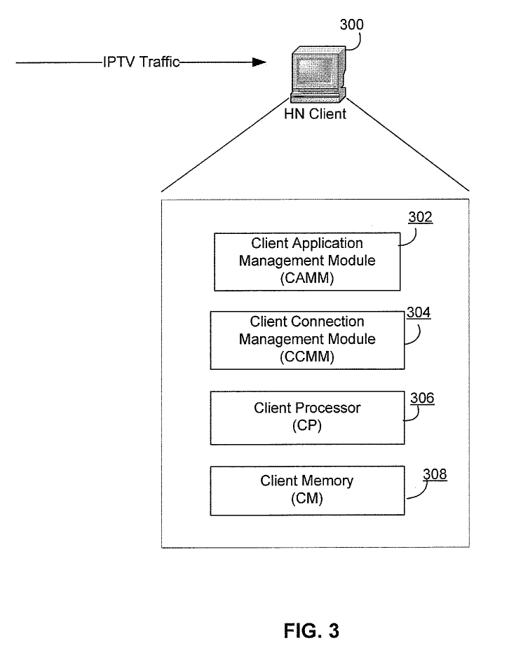

FIG. 3 is a block diagram illustrating an exemplary home network client that is operable to receive IPTV service with desired QoS, in accordance with an embodiment of the invention. Referring to FIG. 3, there is shown a home network (HN) client 300 comprising a client application management module (CAMM) 302, a client connection management module (CCMM) 304, a client processor (CP) 306 and a client memory (CM) 308.

The CAMM 302 may comprise suitable logic, circuitry, interfaces and/or code that are operable to manage various application requirements and status. The various application requirements may comprise information regarding QoS attributes such as a maximal packet error rate. The application status may provide and indication that, for example, the corresponding service may be reserved and/or resumed. The CAMM 302 may be configured to monitor the fixed and variable port numbers used for identifying and monitoring application data. The quality of the monitored application data may be measured using, for example, packet error rate (PER), bit error rate (BER), signal to interference and noise ratio (SINR) and signal to noise ratio (SNR). Depending on the quality of the monitored application data, the CAMM 302 may be operable to send QoS request messages to the CCMM 304 for QoS control.

The CCMM 304 may comprise suitable logic, circuitry, interfaces and/or code that are operable to monitor home network connectivity as well as the available bandwidth, transmission delay, and packet error rate of corresponding link connection with a HN server such as the HN server 200. The CCMM 304 may be configured to handle various session signaling messages. The session signaling messages may comprise, for example, a QoS request message provided by the CAMM 402. The CCMM 304 may be operable to manage corresponding connection sessions according to the received QoS request message for QoS control.

The CP 306 may comprise suitable logic, circuitry, interfaces and/or code that are enabled to control and/or manage data processing operations for the HN client 300. The CP 306 may be operable to process signals such as a QoS request for a program in IPTV service. The CP 306 may be operable to signal the HN server 200 for communication session establishment/re-establishment with a desired QoS in IPTV traffic. In this regard, the CP 306 may be operable to provide the HN server 200 with an actual packet error rate and/or a desired packet error rate for a specific program received in IPTV service. The CP 306 may be operable to perform various operations for session establishment/re-establishment with the HN server 200 to ensure the desired QoS for the specific program in IPTV service. The CP 306 may be operable to receive IPTV packets of the specific program in IPTV service in unicast mode or in multicast mode from the HN server 200.

The CM 308 may comprise suitable logic, circuitry, interfaces and/or code that may be operable to store data and/or other information utilized by the CP 306. For example, the CM 308 may be utilized to store processed data generated by the CP 306. The CM 308 may be operable to store information, such as IP protocols that may be utilized for the reception of IPTV packets from the HN server 200. Communication session information such as session ID received from the HN server 200 may be stored in the CM 308.

In operation, the HN client 300 may be enabled to communicate with the HN server 200 for IPTV service. The CP 306 may be enabled to receive desired QoS information from the CAMM 302 for a specific program in IPTV service. The CP 306 may be operable to evaluate corresponding link quality, for example, actual packet error rate, and provide to the HN server 200 together with the desired QoS information for the specific program in IPTV service. The CP 306 may be operable to communicate with the HN server 200 for selecting local IP protocols for the delivery of the specific program in IPTV service. The CP 306 may be operable to support session establishment or re-establishment with the HN server 200 to ensure the desired QoS for the specific program in IPTV service. The CP 306 may be operable to receive IPTV packets of the specific program in IPTV service in unicast mode or in multicast mode depending on corresponding link quality.

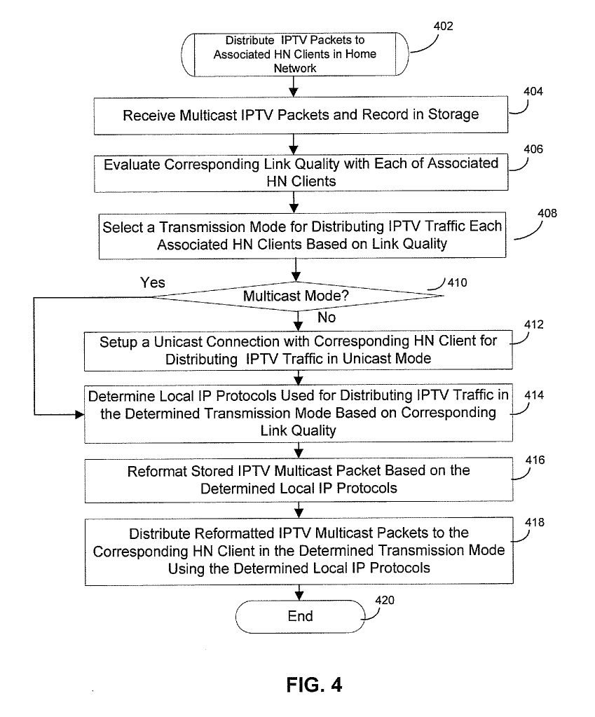

FIG. 4 a flow chart illustrating an exemplary end-to-end service management procedure for the delivery of IPTV service in home network, in accordance with an embodiment of the invention. Referring to FIG. 4, the exemplary steps may start with the step 402, where a HN server such as the HN server 200 may be operable to distribute IPTV packets to associated HN clients such as the HN clients 144a-144c within the home network 140. In step 404, the HN server 200 may be operable to receive multicast IPTV packets from the wide-area distribution network 130. The HN server 200 may enable the storage 208 to record and store the received multicast IPTV packets. In step 406, the HN server 200 may be operable to evaluate corresponding link quality with each of associated HN clients.

In step 406, the HN server 200 may be enabled to select a transmission mode for distributing recorded multicast IPTV packets to each of associated HN clients based on corresponding link quality such as a packet error rate. For example, the HN server 200 may be operable to select a unicast transmission mode for the delivery of the recorded multicast IPTV packets to, for example, the HN client 144a in instances where the corresponding packet error rate is greater than a threshold value. Otherwise, the HN server 200 may be operable to deliver the recorded multicast IPTV packets to the HN client 144a in multicast mode. In step 410, it may be determined whether the selected transmission mode is a multicast mode. In instances where the selected transmission mode is a not multicast mode, then in step 412, the HN server 200 may be operable to setup session in unicast mode with the HN client 144a for distributing the recorded multicast IPTV packets.

In step 414, the HN server 200 may be operable to determine local IP protocols that may be used for distributing the recorded multicast IPTV packets based on corresponding link quality. In step 416, the HN server 200 may be operable to reformat appropriate recorded multicast IPTV packets in the storage 208 based on the determined local IP protocols. In step 418, the HN server 200 may be operable to use the determined local IP protocols to distribute reformatted multicast IPTV packets to the HN client 144a in the determined transmission mode. The exemplary process may end at step 420. In step 410, in instances where the selected transmission mode is a multicast mode, then the exemplary steps may continue to step 414.

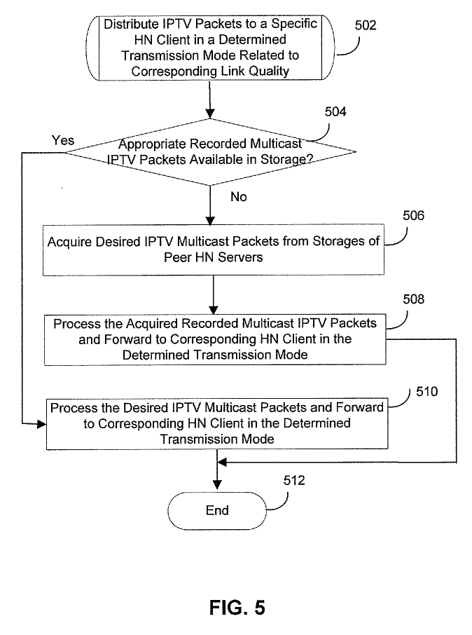

FIG. 5 is a flow chart illustrating an exemplary resource sharing procedure for a seamless IPTV service in home network, in accordance with an embodiment of the invention. Referring to FIG. 5, the exemplary steps may start with the step 502, where a HN server such as the HN server 142a may be operable to distribute IPTV packets to a specific HN client such as the HN client 144a in a determined transmission mode (multicast mode or unicast mode) related to corresponding link quality. In step 504, it may be determined that appropriate recorded multicast IPTV packets are available in associated storage of the HN server 142a. In instances where appropriate recorded multicast IPTV packets are not available in the associated storage such as the storage 208, then in step 506, the HN server 142a may be operable to acquire appropriate recorded multicast IPTV packets from storages of peer HN servers such as the HN server 142b. In step 508, the HN server 142a may be enabled to process the acquired appropriate recorded multicast IPTV packets as described with respect to, for example FIG. 4, and forward the acquired appropriate recorded multicast IPTV packets to the HN client 144a in the determined transmission mode. The exemplary steps stop in step 512.

In step 504, in instances where appropriate recorded multicast IPTV packets are available in the associated storage, then the exemplary steps continues in step 510, where the HN server 142a may be enabled to process the appropriate recorded multicast IPTV packets as described with respect to, for example FIG. 4 and forward to the HN client 144a in the determined transmission mode. The exemplary steps may end at step 512.

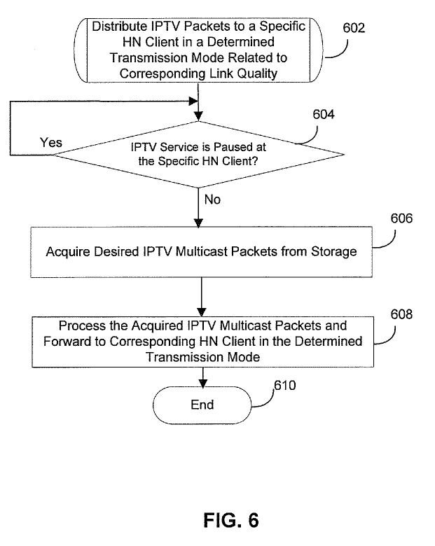

FIG. 6 is a flow chart illustrating an exemplary seamless pause procedure in IPTV service within home network, in accordance with an embodiment of the invention. Referring to FIG. 6, the exemplary steps may start with the step 602, where a HN server such as the HN server 142a may be operable to distribute IPTV packets to a specific HN client such as the HN client 144a in a determined transmission mode (multicast mode or unicast mode) related to corresponding link quality. In step 604, it may be determined whether IPTV service may be paused at the HN client 144a. In instances where the IPTV service may not be paused at the HN client 144a, then in step 606, the HN server 142a may be operable to acquire appropriate recorded multicast IPTV packets from corresponding storage. In step 608, the HN server 142a may be operable to process the acquired recorded multicast IPTV packets as described with respect to, for example FIG. 4, and forward to the HN client in the determined transmission mode. In instances where a service pause has ended at the HN client 144a, the HN server 142a may be operable to resume transmission of IPTV service prior to forwarding IPTV packets. The exemplary steps may end at step 610. In step 604, in instances where IPTV service may be paused at the HN client 142a, then in the exemplary steps stay in step 604. The HN server 142a may be operable to suspend transmission of IPTV service during the service pause at the HN client 142a.

In various exemplary aspects of the method and system for handling IPTV multicast traffic in a home network, a HN server such as the HN server 142a, in the home network 140, may be configured to terminate IP-based multicast packets such as multicast IPTV packets received from an entity such as the wide-area distribution network 130 that is external to the home network 140. The HN server 142a may be operable to transmit the terminated multicast IPTV packets to a plurality of HN clients in the home network 140 based on corresponding link quality such as a packet error rate between each of the plurality of HN clients and the HN server 142a. The HN server 142a may enable the storage 208 of the HN server 142a to record the terminated multicast IPTV packets to be utilized in IPTV service within the home network 140. As described with respect to FIG. 1, FIG. 2 and FIG. 4, the HN server 142a may be operable to determine a transmission mode for each of the plurality of HN clients such as the HN clients 144a-144c based on corresponding link quality between the HN server 142 and each of the HN clients 144a-144c. The determined transmission mode may be utilized for transmission of the recorded multicast IPTV packets in the storage 208. The HN server 142a may be enabled to determine one or more local IP protocols based on corresponding link quality for each of the HN clients 144a-144c. The determined one or more local IP protocols may be used for transmission of the recorded multicast IPTV packets in the corresponding determined transmission mode. The recorded multicast IPTV packets in the storage 208 may be reformatted based on the determined one or more local IP protocols prior to transmission.

The HN server 142a may be operable to transmit the reformatted multicast IPTV packets in the determined transmission mode to corresponding HN clients. With regard to FIG. 5, the HN server 142a may be operable to share resources with peer HN servers such as the HN server 142b in the home network 140. For example, the HN server 142a may be operable to acquire expected recorded multicast IPTV packets from the HN server 142b in instances where the expected recorded multicast IPTV packets are not available in its own storage. The server 142a may be enabled to reformat the acquired multicast IPTV packets based on the determined one or more local IP protocols for transmission in the determined transmission mode to corresponding HN clients. As described with respect to FIG. 6, the server 142a may be operable to control IPTV packet transmission to HN clients such as the HN client 144a to support seamless pause in the home network 140. For example, the HN server 142a may be operable to suspend IPTV packet transmission to the HN client 144a during a service pause at the HN client 144a. The HN server 142a may be operable to resume IPTV packet transmission to the HN client 144a after the service pause at the HN client 144a.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a method and system for handling IPTV multicast traffic in a home network.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
performing by one or more processors and/or circuits in a server located within a home network:
terminating Internet Protocol (IP)-based multicast packets received from an entity that is external to said home network; and
transmitting said terminated IP multicast packets from said server to a plurality of clients in said home network based on corresponding link quality between each of said plurality of clients and said server.

2. The method according to claim 1, comprising recording said terminated IP multicast packets in storage of said server.

3. The method according to claim 2, comprising determining a transmission mode for each said plurality of clients based on corresponding link quality, wherein said determined transmission mode is used for transmission of said recorded IP multicast packets.

4. The method according to claim 3, comprising determining one or more local IP protocols to be utilized in said determined transmission mode based on a corresponding link quality for each said plurality of clients.

5. The method according to claim 4, comprising reformatting said recorded IP multicast packets based on said determined one or more local IP protocols.

6. The method according to claim 5, comprising transmitting said reformatted IP multicast packets, utilizing said determined transmission mode, to said plurality of clients.

7. The method according to claim 4, comprising acquiring expected recorded IP multicast packets from a peer server in said home network when said expected recorded IP multicast packets are not available in said storage of said server.

8. The method according to claim 7, comprising reformatting said acquired IP multicast packets based on said determined one or more local IP protocols for transmission in said determined transmission mode to said plurality of clients.

9. The method according to claim 6, comprising suspending said transmission during a service pause at a specific client of said plurality of clients.

10. The method according to claim 9, comprising resuming said transmission after said service pause at said specific client of said plurality of clients.

11. A system for communication, the system comprising:
one or more processors and/or circuits for use in a server of a home network, wherein said one or more processors and/or circuits are operable to:
terminate Internet Protocol (IP)-based multicast packets received from an entity that is external to said home network; and
transmit said terminated IP multicast packets from said server to a plurality of clients in said home network based on corresponding link quality between each of said plurality of clients and said server.

12. The system according to claim 11, wherein said one or more processors and/or circuits are operable to record said terminated IP multicast packets in storage of said server.

13. The system according to claim 12, wherein said one or more processors and/or circuits are operable to determine a transmission mode for each said plurality of clients based on corresponding link quality, wherein said determined transmission mode is used for transmission of said recorded IP multicast packets.

14. The system according to claim 13, wherein said one or more processors and/or circuits are operable to determine one or more local IP protocols to be utilized in said determined transmission mode based on a corresponding link quality for each said plurality of clients.

15. The system according to claim 14, wherein said one or more processors and/or circuits are operable to reformat said recorded IP multicast packets based on said determined one or more local IP protocols.

16. The system according to claim 15, wherein said one or more processors and/or circuits are operable to transmit said reformatted IP multicast packets in said determined transmission mode to said plurality of clients.

17. The system according to claim 14, wherein said one or more processors and/or circuits are operable to acquire expected recorded IP multicast packets from a peer server in said home network when said expected recorded IP multicast packets are not available in said storage of said server.

18. The system according to claim 17, wherein said one or more processors and/or circuits are operable to reformat said acquired IP multicast packets based on said determined one or more local IP protocols for transmission in said determined transmission mode to said plurality of clients.

19. The system according to claim 16, wherein said one or more processors and/or circuits are operable to suspend said transmission during a service pause at a specific client of said plurality of clients.

20. The system according to claim 14, wherein said one or more processors and/or circuits are operable to resume said transmission after said service pause at said specific client of said plurality of clients.
